(19) United States
(12) Patent Application Publication
(10) Pub. No.: US 2007/0196621 A1
(43) Pub. Date: Aug. 23, 2007

(54) Sprayable micropulp composition

(76) Inventors: Arnold Frances, Glen Allen, VA (US); Eoin Patrick Pierce, Derry (IE); David M. Zukowski, Sterling Heights, MI (US)

Correspondence Address: E I DU PONT DE NEMOURS AND COMPANY;LEGAL PATENT RECORDS CENTER, BARLEY MILL PLAZA 25/1128, 4417 LANCASTER PIKE, WILMINGTON, DE, 19805, US

(21) Appl. No.: 11/699,938

(22) Filed: Jan. 30, 2007

Related U.S. Application Data
(60) Provisional application No. 60/764,436, filed on Feb. 2, 2006.

(51) Int. Cl. B32B 3/04

(52) U.S. Cl. 428/125

(57) ABSTRACT

A composition for coating a surface where the composition has at least one polymer selected from the group of polyurea and polyurethane and a para-aramid micropulp dispersed in the polymer where the micropulp has a volume average length of from 0.01 to 200 micrometers.

### BACKGROUND OF THE INVENTION

1. Field of the Invention

This invention relates to compositions for use in truck beds.

2. Description of Related Art

Conventional bedliners are preformed inserts that protect the bed of a pick-up truck from cargo damage and are typically made of materials such as, polyethylene, polypropylene, or polyvinyl chloride. After installation, such liners have a tendency to crack upon exposure to extreme environmental conditions, thereby separating from the truck bed itself. These “drop-in” liners can present problems with dirt and moisture collecting between the truck bed and the liner. This creates an environment for accelerated corrosion of the substrate beneath the liner.

Sprayable bed liners provide a number or improvements over drop-in liners, including improved corrosion and cracking resistance, while avoiding dirt, moisture, and mud packing problems. However, in order to provide such desired durability, such coatings must be applied at very high film build-up. As such, they add considerable mass to the truck bed of potentially dangerous and very combustible organic material. Therefore, there is a need for coating compositions which are flame resistant. Further, the spray-in products are generally not considered to be as tough as their drop-in competitors. Market research has indicated that a demand exists for a premium spray-in bedliner with improved toughness and durability as manifested by improved cut and puncture resistance, improved tear strength and increased modulus. Spray-in bedliners provide a quieter, better fitting alternative with several performance advantages. Sprayable epoxy, polyurethane, or polyurea are examples of the chemistries used in such compositions. These coatings typically contain a curable resin as the main film-forming component, an elastomeric component, and a reinforcing filler.

Standard Kevlar® pulp has been used in this market to provide reinforcing benefits. Keviar® is an aromatic polyamide (or aramid), specifically poly(p-phenylene terephthalamide), available from E. I. du Pont de Nemours and Company, Wilmington, Del. (DuPont). As used herein, “aramid” means a polyamide wherein at least 85% of the amide (—CONH—) linkages are attached directly to two aromatic rings. However, the fiber size of the standard Kevlar® pulps causes application problems and can plug the spray nozzles causing inefficiencies and non-uniformities. In addition to the nozzles, other parts of the spray equipment such as check valves, springs, and the like may be adversely affected.

As noted in US Patent Publication US 2002/0137871 A1, a problem with the use of standard Kevlar® pulp for reinforcing polyurethane resins, for example, is that the fiber can separate from the polyurethane and/or deteriorate, thereby compromising the advantage of adding the Kevlar® fiber as evidenced by decreased strength and stability.

As disclosed in International Patent Publication WO 03/044250, standard Kevlar® fibers can be converted into micropulp having a volume average length ranging from 0.01 micrometers to 100 micrometers. As disclosed in International Patent Publication WO 03/044100, such micropulp can be used in a coating composition to make a coating with improved chip resistance with no appreciably adverse impact on coating appearance.

### BRIEF SUMMARY OF THE INVENTION

This invention includes a sprayable truck bedliner containing 0.01 to 3.0% micropulp, preferably 0.05 to 1.0% micropulp and more preferably 0.1 to 0.5% micropulp. The volume weighted average length for the micropulp can be 0.1 to 200 micrometers, preferably 1 to 150 micrometers, more preferably 5 to 100 micrometers and most preferably 5 to 50 micrometers.

### DETAILED DESCRIPTION OF THE INVENTION

It is an object of the present invention to provide a sprayable coating composition which possesses flame resistance, as well as possessing the ability to withstand the frictional and durability requirements of a truck bed. It is another object of the invention to render such composition conductive to minimize the possibility of generating static electricity that may ignite gasoline that may be stored on the truck bed or may be a hazard during the gasoline filling operation. It is also desirable that such a coating be capable of being applied over a variety of topcoats and have excellent adhesion by using conventional spray equipment. Moreover, it is an object of this invention that the spray equipment orifices typically in the range of 0.02 to 0.08 inches (0.51 to 2.03 mm) do not plug in operation.

It has been found that the use of the newly developed micropulp technology can provide improvements in material strength, modulus, cut resistance, puncture resistance, and tear strength without any special spray equipment modifications or application issues. Whereas, commercial pulp that plugs spray equipment typically has a length of about 500 micrometers, but micropulp with lengths as high as 200 micrometers do not plug similar equipment.

Micropulp

As used herein, micropulp is a processed organic fiber having a volume average length ranging from 0.01 to 200 micrometers or 0.1 to 200 micrometers or 1 to 150 micrometers or 5 to 150 micrometers or 5 to 50 micrometers. Such micropulp generally has an average surface area ranging from 25 to 500 square meters per gram. The micropulp of the present invention is a fibrous organic material that includes an intermeshed combination of two or more webbed, dendritic, branched, mushroomed or fibril structures.

Micropulp is made by contacting an organic fiber with a medium comprised of a liquid component and a solid component and then agitating the combination to size reduce and modify the organic fiber. The organic fiber used as a starting material can include pulp, short fiber, fibrids, or mixtures of these forms. Through this treatment the micropulp is uniformly dispersed in the liquid component.

Pulps can be made by refining short fibers between rotating discs to cut and shear the fibers into smaller pieces. Pulp particles differ from short fibers by having a multitude of fibrils or tentacles extending from the body of each pulp particle. These fibrils or tentacles provide minute hair-like anchors for reinforcing composite materials and cause the pulp to have a very high surface area. A particularly useful starting material is aramid pulp, which is well known in the art and can be made by refining aramid fibers to fibrillate the short pieces of aramid fiber material. Such pulps have been reported to have a surface area in the range of 4.2 to 15 meters²/gram and a Kajaani weight average length in the range of 0.6 to 1.1 millimeters (mm). Such pulps have high volume average length, compared to the micropulp. For example, Style 1 F543 Kevlar® pulp (available from DuPont) has a Kajaani weight average length in the range of 0.6 to 0.8 mm, and when laser defraction is used to measure this pulp the volume average length is 500 to 600 micrometers (0.5 to 0.6 mm). An alternate method of making aramid pulp directly from a polymerizing solution is disclosed in U.S. Pat. No. 5,028,372.

Polymers

Suitable polymers for use with the micropulp of this invention include polyurethane, polyurea, and other suitable compositions which can include both aliphatic and aromatic compositions.

Polyurethanes are made by contacting isocyanate components/materials and polyol components/materials. Suitable isocyanate components for making polyurethanes are described in U.S. Pat. No. 6,613,389. Suitable polyol components for making polyurethanes include, without limitation, linear or branched diols or polyols, including alkyl diols, triols, or polyols, polyester, polyester polyols, polyether (ethylene or propylene chain) polyols, acrylic polyols, and caprolactam-based polyols.

Polyureas are made by contacting polyether amine components/materials and isocyanate components/materials. Suitable isocyanate components for making polyureas are described in U.S. Pat. No. 6,613,389.

Suitable amine components for making polyureas include, without limitation, diamines, polyamines, polyether amines, and hindered secondary amine adducts. Suitable amines are also described in U.S. Pat. No. 6,613,389 and U.S. Pat. No. 6,369,189.

In one process for coating a surface with a protective polymeric structure in accordance with this invention requires an organic fiber, a solid component, and a first reaction component. The organic fiber can be aramid fibers in the form of micropulp. Preferred aramids include poly(p-henylene terephthalamide), poly(m-phenylene isophthalamide), and mixtures thereof. The solid component can be any medium suitable for grinding such as zirconium oxide and the like. The first reaction component can be polyol, polyamine, diamine, and mixtures thereof.

The organic fiber, the solid component, and the first reaction component are agitated together to transform the organic fiber into a micropulp having a volume average length of from 0.01 to 200 micrometers so that it is dispersed in the first reaction component. After removing the solid component a first reaction mixture remains, which is then contacted with a second reaction component The second reaction component can be a polyisocyanate, di-isocyanate, or reaction products of diisocyanates having an isocyanate functionality. Mixing the first reaction mixture with the second reaction component forms a liquid polymer. The liquid polymer can be polyurethane, polyurea, or mixtures thereof; and the micropulp is then dispersed in the liquid polymer. When the micropulp is dispersed in liquid polymer, the weight percent of the micropulp is 0.01 to 3.0 weight percent of the polymer plus the micropulp or 0.05 to 1 weight percent or even 0.1 to 0.5 weight percent. The liquid polymer with the dispersed micropulp forms a mixture that can then be successfully sprayed through a nozzle onto a surface without plugging the nozzle or other parts of the spraying equipment. After application to the surface, the liquid polymer/micropulp mixture is cured and/or dried to form a flexible solid protective polymeric structure on the surface, such as the bed of a truck.

Test Methods

The following test methods were used in the following Examples.

Tensile Strength is the maximum or breaking stress of a material as expressed as force per unit cross-sectional area and determined in accordance with ASTM D 412. The tensile strength is measured on an Instron model 1130 available from Instron of Canton, Mass. and is reported as lbs./sq. in. (Mpa).

Puncture resistance is expressed in lbs. and was determined in accordance with ASTM F-1342.

Tear resistance is expressed in lbs./in. and was measured in accordance with ASTM D-624.

Kaiaani weight average length is determined following standard operating procedures using a Kajaani fiber length analyzer.

Volume weighted average length was determined using a Beckman Coulter LS 200 laser diffraction particle size analyzer.

### EXAMPLES

This invention will now be illustrated by the following specific examples. All parts and percentages are by weight unless otherwise indicated. Examples prepared according to the process or processes of the current invention are indicated by numerals and comparative or control examples are indicated by letters.

A 1.0 wt % mixture of pulp was produced by adding 69 g of Kevlar® pulp merge 1 F543 (pre-dried in an oven at about 110 deg C) to 6822 g of PL-5264 polyester resin that was developed by DuPont. The PL-5264 composition was made by reacting a mixture of (by weight) 9.13% trimethylol propane, 22.20% neopentyl glycol, 42.86% adipic acid, and 25.81% 1,6-hexanediol. The mixture was heated in a reactor with water separator to a maximum of 225° C., and by-product water collected, until an acid number of less than 5 was obtained. The end product had a hydroxyl equivalent weight of approximately 176 g per equivalent. The pulp and the polyester were agitated in a tank of about 10 liters at a speed of about 200-500 rpm with a Cowles type agitator, available from Premier Mill, Reading, Pa. Nitrogen was purged over the top of the closed tank to minimize water pickup. After about five minutes of agitation, two liters were pumped directly out of the tank as representative of commercial Kevlar® pulp. The fiber length was measured using a Beckman Coulter LS200 particle size analyzer, available from Beckman Coulter, Fullerton, Calif. This mixture was designated as TBL-1 and had a volume weighted average length of 370.6 micrometers.

A second charge of material consisting of 5488 g of the polyester resin and 55.5 g dried Kevlar® pulp was added to the remaining material in the tank from above and agitated for another 5 minutes. Once completely mixed, the mixture was passed through a 1.5 liter Premier media mill, available from: Premier Mill, Reading, Pa. with 1.0 mm zirconium oxide media at a 75% volumetric charge. The mill was operated at 2250 feet per minute, 7.2 kw, with a flow rate of 128 g/min. One liter of this mix was purged through the mill and discarded. Then two (2) liters of material were collected from the exit of the mill (a single pass of product through the mill). This mixture was designated as TBL-2 and had a volume weighted average length of 185.1 micrometers.

After the collection of the two liters above, the flow was set up in recirculation with the exit of the mill feeding back into the tank. After 30 minutes of recirculation, two more liters were collected. This mixture was designated as TBL-3 and had a volume weighted average length of 67.3 micrometers.

The mill was then set back into recirculation and the mixture was recirculated for another 2 hrs. (or 2.5 hrs. total) and approximately three (3) liters were collected. This mixture was designated as TBL4 and the volume weighted average length was 34 micrometers.

### Examples 1-2 and Comparative Examples A-C

TBL-1 and TBL-3 were diluted with additional resin and reacted with an isocyanate mixture of 75% by weight Desmodur N-3400 and 25% Desmodur N3300 available from Bayer Corp, Pittsburgh, Pa. so that the final urethane compositions contained 0.1 and 0.3% of pulp (or micropulp), respectively. The compositions were cast into molds to form urethane slabs. However, one slab was produced without any Kevlar® and tested for mechanical properties, which are presented in the table below as Comparative Example A. Slabs were made from TBL-1 with 0.1% pulp and with 0.3% pulp and were tested for mechanical properties, which are presented in the table below as Comparative Examples B and C, respectively. Slabs were made from TBL-3 with 0.1 and with 0.3 wt % Kevlar® micropulp and were tested for mechanical properties, which are presented in the table below as Examples 1 and 2, respectively.

TABLE 1

| | PUNCTURE | TEAR | STRESS | ELONGATION |
|---|---|---|---|---|
| EXAMPLE | (lbs) | (lbs/in) | (psi) | % |
| Comp A | 24.7 | 143.8 | 1410 | 116.3 |
| Comp B | 25.1 | 153.1 | 1374 | 110.4 |
| Comp C | 23.5 | 156.6 | 1113 | 86.2 |
| 1 | 25.6 | 158.6 | 1581 | 116.1 |
| 2 | 28.2 | 181.1 | 1460 | 88.6 |

The results in the table above demonstrate that although the inventive micropulp is sprayable, there is no compromise (and, in some cases, an improvement) of the mechanical properties that are desirable for a bedliner.

What is claimed is:

1. A composition for coating a surface, comprising:
at least one polymer selected from the group consisting of polyurea and polyurethane,
a para-aramid micropulp dispersed in the polymer, the micropulp having a volume average length of from 0.01 to 200 micrometers.

2. The composition of claim 1, the micropulp having a volume average length of from 0.1 to 200 micrometers.

3. The composition of claim 1, wherein the micropulp has a volume average length of from 1 to 150 micrometers.

4. The composition of claim 1, wherein the micropulp has a volume average length of from 5 to 150 micrometers.

5. The composition of claim 1, wherein the micropulp has a volume average length of from 5 to 50 micrometers.

6. The composition of claim 1, wherein the weight percent of the micropulp is 0.01 to 3.0 weight percent of the polymer plus the micropulp.

7. The composition of claim 6, wherein the weight percent of the micropulp is 0.05 to 1 weight percent.

8. The composition of claim 6, wherein the weight percent of the micropulp is 0.1 to 0.5 weight percent.

9. The composition of claim 1, wherein the para-aramid is selected from the group consisting of poly(p-phenylene terephthalamide), poly(m-phenylene isophthalamide and a mixture thereof.

10. The composition of claim 9, wherein the para-aramid is poly(p-phenylene terephthalamide).

11. The composition of claim 1, capable of being sprayed through a sprayer having orifices no larger than 0.080 inch (2.03 mm) without plugging the orifice to form a micropulp-reinforced polymeric protective structure on the surface.

12. A surface coated with the protective layer of claim 6, wherein the surface is made of a material selected from the group consisting of metal, fiberglass, and plastic.

13. The surface of claim 12, wherein the surface is a protective liner for a vehicle bed.

14. A process for coating a surface with a protective polymeric structure, comprising:
contacting organic fiber, a solid component, and at least a first reaction component selected from the group consisting of polyol, polyamine, diamine, and mixtures thereof;
agitating the organic fiber, the solid component, and the first reaction component to transform the organic fiber into a micropulp having a volume average length of from 0.01 to 200 micrometers that is dispersed in the first reaction component;
removing the solid component to form a first reaction mixture;
contacting the first reaction mixture with a second reaction component selected from the group consisting of polyisocyanate, di-isocyanate, and reaction products of diisocyanates having isocyanate functionality,
mixing the first reaction mixture with the second reaction component to form a liquid polymer selected from the group consisting of polyurethane, polyurea, and mixtures thereof wherein the micropulp is dispersed in the liquid polymer;
spraying the liquid polymer through a nozzle onto the surface without plugging the nozzle, and
drying the liquid polymer to form a flexible solid protective polymeric structure on the surface.

15. The process of claim 14, wherein the curing step is drying.

16. The process of claim 14, wherein the organic fiber is a para-aramid selected from the group consisting of poly(p-phenylene terephthalamide) and poly(m-phenylene isophthalamide).

17. The process of claim 16, wherein the para-aramid is poly(p-phenylene terephthalamide).
